(19) United States
(12) Patent Application Publication
(10) Pub. No.: US 2023/0151672 A1
(43) Pub. Date: May 18, 2023

(54) Automatic Opening and Closing Device of Door

(71) Applicant: Jeff Chen, Chiayi County (TW)

(72) Inventor: Jeff Chen, Chiayi County (TW)

(21) Appl. No.: 17/868,778

(22) Filed: Jul. 20, 2022

(30) Foreign Application Priority Data
Nov. 12, 2021 (TW) 110213426

(51) Int. Cl. E05F 15/73; E05B 81/04; E05B 81/56; E05F 15/60

(52) U.S. Cl. CPC E05F 15/73; E05B 81/04; E05B 81/56; E05F 15/60; E05Y 2201/434; E05Y 2400/40; E05Y 2400/44; E05Y 2900/531

(57) ABSTRACT

An automatic opening and closing device of door includes a locking unit arranged on the door, a door driving unit configured for driving the door to open or close, a signal receiving unit configured for receiving external or internal signals of the door, and a control unit electrically communicated and connected with the signal receiving unit. The locking unit includes a lock and a power motor. The power motor and the door driving unit are electrically communicated and connected with the control unit. When the signal receiving unit senses a correct door opening signal from the inside or outside of the door, the control unit will first command the power motor to drive the lock to be unlocked and command the door driving unit to act to open the door. After a person has passed the door, the control unit will command the door driving unit to act to close the door and command the power motor to link and drive the lock to be locked. It can be noted that the person does not need to contact any part of the door or the lock, so as to prevent virus infection, which achieves an epidemic prevention effect.

### BACKGROUND OF THE PRESENT INVENTION

### Field of Invention

The present invention relates to an automatic opening and closing device of door, and more particularly to an automatic opening and closing device of door that is capable of automatically opening and closing a door as well as locking and unlocking the lock.

### Description of Related Arts

It is noted that since the outbreak of the COVID-19 pandemic, in order to avoid the virus infection, people have to keep a social distance interpersonally, wear mask, and wash hands regularly. In other words, besides of droplet transmission, the most direct infection pathway is having a hand to touch an object with virus, and then contact the eyes, the mouth or the nose. That is why reducing touching objects with hands and washing hands frequently can significantly lower the risk of being infected by the virus. Nevertheless, people have to get in and out of doors every day. To do that, she or he has to conduct two actions. One is the unlocking or locking of the lock, and the other is the opening or closing of the door. Both require utilizing a hand to contact the door and lock. Before the outbreak of the pandemic, some of the doors are designed to be opened or closed through using a large motor driven by 120 Volt current, but such doors are not suitable for a smaller sized household door. However, locks suitable for household doors with technologies of automatic unlocking and locking have been widely used. For example, Taiwan patent application numbers 107212936, 107204018, 107202105, 110206364, 109216646, 110201248, 109217253, and etc. Meanwhile, technologies related to doors being automatically opened are more common, which will not be repeated here. Nonetheless, although locks of the foregoing lock-related technologies can be unlocked or locked automatically, a person still needs to manually open and close the door and touch the door handle, which still creates a risk of virus infection. In addition, it is noted that there is no lock that is capable of locking and unlocking automatically designed for regular automated doors. Namely, there has not been technology containing both automated lock and automated door in the market, which leaves people under a virus infection risk.

### SUMMARY OF THE PRESENT INVENTION

Hence, an object of the present invention is to provide an automatic opening and closing device of door serving an epidemic prevention function.

Accordingly, the automatic opening and closing device of door of the present invention is adapted for controlling an opening or closing of a door as well as an unlocking and locking of the door. The automatic opening and closing device of door comprises a locking unit configured for being arranged on a door, a door driving unit configured for driving the door to open or close, a signal receiving unit configured for receiving external or internal signals of the door, and a control unit electrically communicated and connected with the signal receiving unit. The locking unit comprises a lock and a power motor. The power motor and the door driving unit are electrically communicated and connected with the control unit. When the signal receiving unit senses a correct door opening signal from the inside or outside of the door, the control unit will first command the power motor to drive the lock to be unlocked and command the door driving unit to act to open the door. After the person has passed the door, the control unit will command the door driving unit to act to close the door and command the power motor to link and drive the lock to be locked. It can be understood that the unlocking and locking as well as the opening and closing of the door are completely automatic during the entire process, so that the person does not need to contact any part of the door or the lock, so as to prevent virus infection, which achieves an epidemic prevention effect.

### BRIEF DESCRIPTION OF THE DRAWINGS

FIG. 1 illustrates a block diagram of an automatic opening and closing device of door according to a preferred embodiment of the present invention.

### DETAILED DESCRIPTION OF THE PREFERRED EMBODIMENT

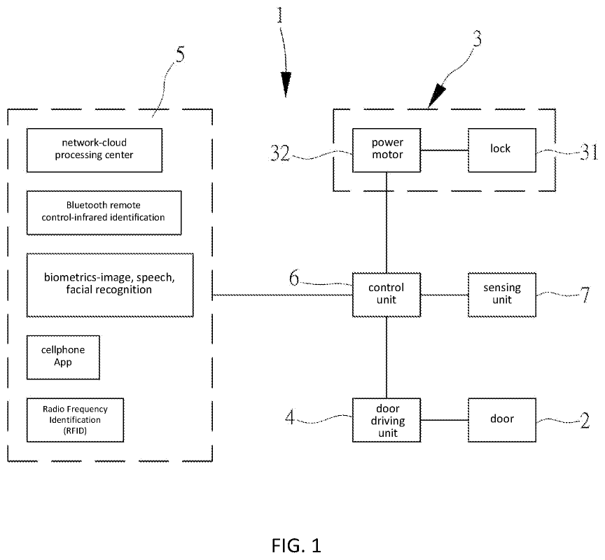

Referring to FIG. 1, an automatic opening and closing device 1 according to a preferred embodiment of the present invention is utilized for controlling the opening and closing of a door 2 and a locking and unlocking of the door 2. The automatic opening and closing device 1 comprises a locking unit 3 arranged on the door 2, a door driving unit 4 configured to drive the door 2 to open or close, a signal receiving unit 5 configured to receive a signal from the outside or inside of the door 2, a control unit 6 electrically communicated and connected with the signal receiving unit 5, and a sensing unit 7. The locking unit 3 comprises a lock 31 and a power motor 32. The power motor 32 is coupled with the lock 31, which structure may be implemented as the latch mechanism, as illustrated in Taiwan Pat. App. Nos. 109217253, 110201248, and 109216646, which mainly utilize a motor element to drive a lock bolt to act in order to open or close the latch, which are conventional arts and briefly described hereinafter for the details thereof being not technical features of the present invention. Simply, when the power motor 32 acts, it can drive the lock 31 to lock or unlock. Further, both of the power motor 32 and the door driving unit 4 are respectively electrically communicated and connected with the control unit 6. Besides, the implementing manners of the signal receiving unit 5 are many and conventional. The present embodiment provides a few examples which are not being described in detail, including: cloud processing center with the internet, Bluetooth remote control with infrared identification, image, speech, and facial recognition of the biometrics, Radio Frequency Identification (RFID), cellphone App, and etc. The control unit 6 is adapted for receiving the actuating signal from the signal receiving unit 5 and then orderly commanding the locking unit 3 and the door driving unit 4 to act. More specifically, when the signal receiving unit 5 detects a correct door opening signal from the outside of the door 2, the control unit 6 will first command the power motor 32 to drive the lock 31 to unlock and then command the door driving unit 4 to act to open the door 2. The sensing unit 7 is also electrically communicated and connected with the control unit 6 and is adapted for sensing if the person has passed the door 2. After the person has passed the door 2, the sensing unit 7 will send a door closing signal to have the control unit 6 to command the door driving unit 4 to drive the door 2 to close and then command the power motor 32 to drive the lock 31 to lock. Similarly, when the signal receiving unit 5 receives a correct door opening signal from the inside of the door 2, the control unit 6 will also first command the power motor 32 to drive the lock 31 to unlock and then command the door driving unit 4 to open the door 2. After the person has passed the door 2, the sensing unit 7 will send a signal to have the control unit 6 send commands for the door 2 to close and to lock.

It can be understood based on the above descriptions that the automatic opening and closing device of door 1 of the present invention is completely automatic in the unlocking or closing process of the door 2 as well as in the opening or closing process of the door 2, so that a person does not need to contact any part of the door 2 or the lock 31, so as to prevent virus infection achieve an epidemic prevention effect.

It should be further noted that, if the door lock arranged on the user's home is the latch driven by a motor element to be opened or closed thereby, as shown in the above three prior arts, the user may utilize the automatic opening and closing device of the present invention without replacing the latch to achieve the epidemic prevention effect.

What is claimed is:

1. An automatic opening and closing device for a door, adapted for controlling a door to open or close and lock or unlock the door, comprising:
a locking unit, arranged on the door, comprising a lock and a power motor;
a door driving unit configured for driving the door to open or close;
a signal receiving unit configured for receiving external or internal signals of the door; and
a control unit electrically communicated and connected with said signal receiving unit, wherein said power motor and said door driving unit are electrically communicated and connected with said control unit, such that when said signal receiving unit senses a correct door opening signal from an inside or outside of the door, said control unit commands said power motor to drive said lock to be unlocked and commands said door driving unit to act to open the door, wherein after a person has passed the door, said control unit commands said door driving unit to act to close the door and commands said power motor to link and drive said lock to be locked.

2. The automatic opening and closing device, as recited in claim 1, further comprising a sensing unit electrically communicated and connected with said control unit, wherein said sensing unit sends a door closing signal to said control unit after a person has passed through the door so as to close and lock the door.
